(19) United States
(12) Patent Application Publication
(10) Pub. No.: US 2024/0102681 A1
(43) Pub. Date: Mar. 28, 2024

(54) Remote Monitoring of Heating, Ventilation, and Air Conditioning Devices

(71) Applicant: Rheem Manufacturing Company, Atlanta, GA (US)

(72) Inventor: Michael John Knieser, Fishers, IN (US)

(21) Appl. No.: 18/471,535

(22) Filed: Sep. 21, 2023

Related U.S. Application Data
(60) Provisional application No. 63/376,710, filed on Sep. 22, 2022.

(51) Int. Cl. F24F 11/56; F24F 11/61

(52) U.S. Cl. CPC F24F 11/56; F24F 11/61

(57) ABSTRACT

The systems and methods described herein allow for data produced by an HVAC device to be selectively shared with a third party, such as a contractor used to perform maintenance services on the HVAC device. The system and methods also allow for HVAC devices to be remotely configured to share data based on certain triggering conditions. Specifically, a controller built into an HVAC device may include a configuration file, which may dictate rules associated with collection and transmission of data by the HVAC device. A remote server may be configured to passively listen for data transmissions from any HVAC devices.

### CROSS-REFERENCE TO RELATED APPLICATIONS

This application claims priority to and benefit of U.S. provisional patent application No. 63/376,710 filed Sep. 22, 2022, which is herein incorporated by reference.

### TECHNICAL FIELD

The application relates generally to heating, ventilation, and air conditioning (HVAC) devices, and more particularly to remote monitoring of data produced by the HVAC devices.

### BACKGROUND

HVAC devices (for example, furnaces, air conditioners, and/or any other types of HVAC devices) may sometimes include connectivity capabilities. For example, an HVAC device may include a controller that may allow the device to transmit data to other devices and/or to the device manufacturer. However, such data may not be easily accessible by any third parties, such as contractors or other partners. Additionally, there may not necessarily be an effective approach for monitoring the data produced by the device.

### SUMMARY

In aspects, a system is provided. The system may include one or more processors and memory. The memory may store computer-executable instructions that, when executed by the one or more processors, cause the one or more processors to receive, by a first heating, ventilation, and air conditioning (HVAC) device and from one or more remote servers, a configuration file. The memory may also cause the one or more processors to determine, based on the configuration file, that a first data transmission criteria for a first type of data is satisfied. The memory may also cause the one or more processors to transmit, to the one or more remote servers, and based on the first data transmission criteria for the first type of data being satisfied, first data of the first type of data.

In aspects, a method is provided. The method may include receiving, by a first heating, ventilation, and air conditioning (HVAC) device and from one or more remote servers, a configuration file. The method may also include determining, by the first HVAC device and based on the configuration file, that a first data transmission criteria for a first type of data has been satisfied. The method may also include transmitting, by the first HVAC device, to the one or more remote servers, and based on the first data transmission criteria for the first type of data being satisfied, first data of the first type of data.

In aspects, a heating, ventilation, and air conditioning (HVAC) device is provided. The HVAC device may include one or more processors and memory. The memory may store computer-executable instructions that, when executed by the one or more processors, cause the one or more processors to receive, by the HVAC device and from one or more remote servers, a configuration file. The memory may also cause the one or more processors to determine, by the HVAC device and based on the configuration file, that a first data transmission criteria for a first type of data has been satisfied. The memory may also cause the one or more processors to transmit, by the HVAC device, to the one or more remote servers, and based on the first data transmission criteria for the first type of data being satisfied, first data of the first type of data.

### BRIEF DESCRIPTION OF THE DRAWINGS

FIG. 1 is an example system, in accordance with one or more embodiments of the disclosure.

FIG. 2 is an example flow diagram for a timed data transmission method, in accordance with one or more embodiments of the disclosure.

FIG. 3 is an example flow diagram for a triggered data transmission method, in accordance with one or more embodiments of the disclosure.

FIG. 4 is an example method for remote device monitoring, in accordance with one or more embodiments of the disclosure.

FIG. 5 is an example flow diagram illustrating network communications, in accordance with one or more embodiments of the disclosure.

FIG. 6 is an example computer architecture, in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar but not necessarily the same or identical components; different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

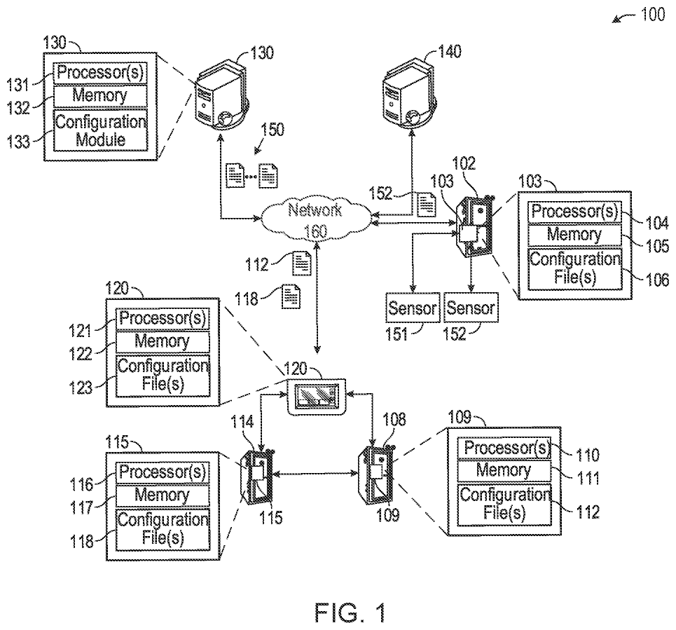

This disclosure relates to, among other things, remote monitoring of heating, ventilation, and air conditioning (HVAC) devices. Particularly, the systems and methods described herein allow for data produced by an HVAC device to be selectively shared with a third party, such as a contractor, in order to perform maintenance services on the HVAC device. These systems and methods may be applicable to both connected and non-connected HVAC devices (and/or any other types of HVAC devices), which are described in additional detail with respect to FIG. 1. Although reference is made herein to HVAC devices, the systems and methods described herein may also be applicable to other types of devices, such as water heaters and other types of residential or commercial appliances.

The system and methods also allow for HVAC devices to be remotely configured to share data based on certain triggering conditions. Specifically, a controller (which may be built into or may be remote) of an HVAC device may be provided a configuration file, which may dictate rules associated with the collection and transmission of data by the HVAC device. A remote server may be configured to passively listen for data transmissions from any HVAC devices. In one or more embodiments, a configuration file may dictate data communication methods for an HVAC device: (1) a timed data transmission method and/or (2) a triggered pushing method.

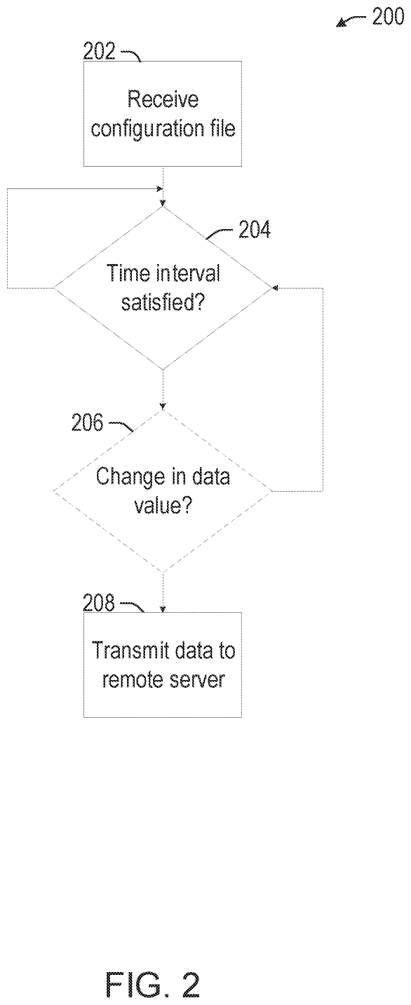

An HVAC device including a configuration file indicating a timed data transmission method may be configured to transmit data at certain time intervals. That is, the triggering condition in this instance may be time. As an illustration of the operation of the HVAC device with this configuration file, the configuration file may include a “frequency” variable that may indicate the frequency at which the HVAC device may transmit data. In some instances, the frequency variable may be associated with a value. For example, a frequency variable with a value of “0” may indicate that data may be transmitted to the remote server at the point of connection between the HVAC device and the remote server. Likewise, a non-zero frequency value may indicate that data may be communicated at a time interval based on the non-zero frequency value if any of the identified data have changed. For example, a frequency value of “15” may indicate that data may be transmitted to the remote server every 15 minutes, 15 seconds, or any other interval of time. If none of the data has changed within a given interval, then no data is communicated at the next time interval. Additionally, in some cases, data may be transmitted at a time interval based on the frequency variable in the configuration file even if the data has not changed within a given time interval. This specific variable within the configuration file is merely exemplary and the configuration file may indicate the time intervals at which data may be transmitted in any other manner. The timed data transmission method is illustrated further in the example of FIG. 2.

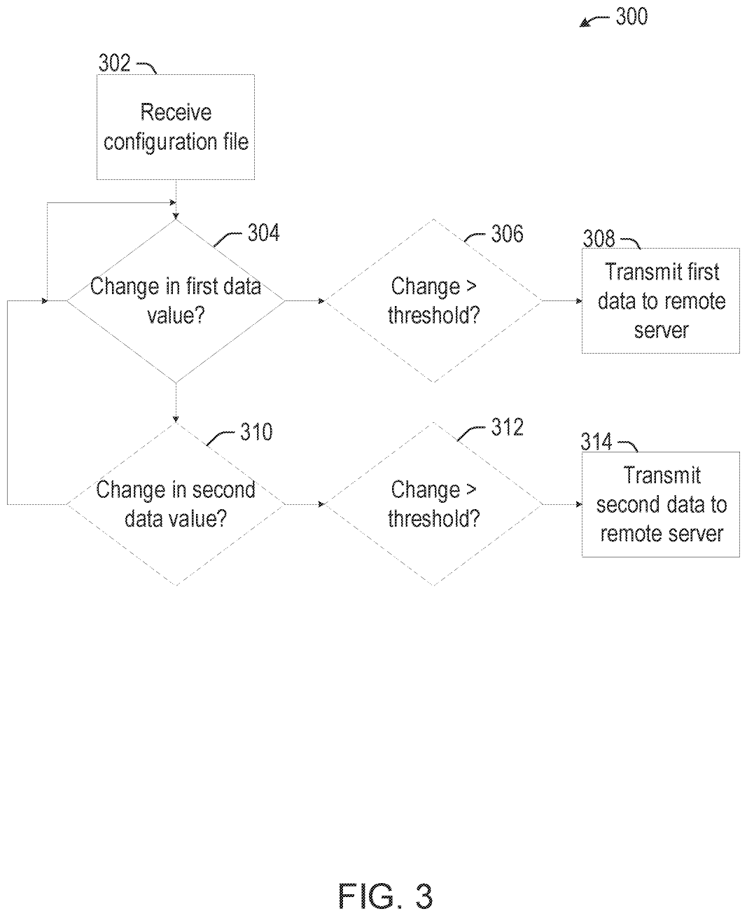

An HVAC device including a configuration file indicating a triggered data transmission method may be configured to transmit data at any point in time when data associated with a defined data type changes. That is, the triggering condition in this instance is a change in certain data values. Any number of different types of data may be defined in the configuration file as the trigger data (some examples are provided with respect to FIG. 1). In this manner, there may be multiple types of data that may trigger data transmission to the one or more remote servers when the values of those types of data change. Additionally, the configuration file may also include threshold values that must be met before the triggering conditions associated with any of the data types are satisfied. For example, the thresholds may indicate a magnitude of change or a magnitude of change within a time window in a value associated with a type of data that is required before data is transmitted. Such thresholds may be used to ensure that only changes of a non-negligible degree are transmitted to the remote server to limit the amount of bandwidth that is used for such transmissions. However, these threshold values may not necessarily be used with respect to some HVAC devices, and instead, data may be transmitted any time the data values change, regardless of the degree of the change. The triggered data transmission method is illustrated further in FIG. 3.

In one or more embodiments, the configuration file may also be remotely updated. The HVAC configuration file may be remotely updated for any number of different reasons. For example, it may be desired to transition an HVAC device from transmitting data based on a triggered data transmission method to a timed data transmission method (or vice versa). As another example, it may be desired to modify the time interval at which data is transmitted under the timed data transmission method (to increase or decrease transmission frequency). As a further example, it may be desired to modify the types of data that are monitored as the triggering conditions for a triggered data transmission method. In another example, it may be desired to modify the threshold values that must be met before the triggering conditions associated with any of the data types are satisfied. These are just a few examples of reasons for configuration file updates and are not intended to be limiting in any way.

The remote update of the configuration file may be performed in a number of different ways. For example, an updated configuration file may be transmitted to the HVAC device by the remote server and/or the configuration file may be remotely provided to the HVAC device initially at device installation. Additionally, configuration file updates may also be shared between various HVAC devices and/or other types of devices. For example, an updated configuration file may be transmitted by the remote server to a first HVAC device at a location. This HVAC device may then transmit the updated configuration file to a second HVAC device at the location as well. Additional details regarding such transmissions are provided with respect to FIG. 1.

Turning to the figures, FIG. 1 is an example system 100, in accordance with one or more embodiments of the disclosure. The system 100 may include at least one or more HVAC devices (for example, HVAC device 102, HVAC device 108, HVAC device 114, thermostat 120, and/or any other number of HVAC devices), one or more remote servers 130, and/or one or more servers 140.

The one or more HVAC devices may be any type of HVAC device (for example, while the HVAC devices shown in the figure are furnaces, this is merely exemplary and any other type of HVAC device and/or combination of different types of HVAC devices may also be applicable as well). Any of the HVAC devices may be provided in a similar location or in different locations. For example, the system 100 may include HVAC devices in various residential and/or commercial settings. The figure shows a first location including the first HVAC device, the second HVAC device, and a thermostat. The figure also shows a second location including a second HVAC device. This illustrates that the remote monitoring may be performed with respect to any number of HVAC devices in a number of different locations.

Additionally, even HVAC devices of the same type may include differing communication capabilities. That is, some devices may be considered “connected HVAC devices” and some may be considered “non-communicating HVAC devices.” As one non-limiting example, a first furnace may be a connected HVAC device and a second furnace may be a non-communicating HVAC device (this may apply to any other type of HVAC device as well).

A connected HVAC device may be classified as a device that is configured to communicate with other devices. For example, the figure shows HVAC device 108 and HVAC device 114 as being configured to communicate with one another through controller 109 and controller 115. As another example, one of these connected components may be the thermostat 120, which may have Wi-Fi connectivity (or other types of connectivity) to the Internet and to one or more servers (for example, the one or more servers 130) associated with the HVAC device manufacturer. With this communication channel, data associated with a given HVAC device may be transmitted to the one or more servers 130. The data may then be selectively shared with third parties (for example, the one or more servers 140), such that both the manufacturer and selected third parties may provide value-added services for the customer.

A non-communicating HVAC device may include a collection of sensors connected to a controller of the HVAC device. An example of this type of device is shown through HVAC device 102, which is in communication (through controller 103) with sensor 151 and sensor 152 (although the number of sensors is merely exemplary and any other number of sensors may be in communication with an HVAC device as well). The sensors may include any number of different types of sensors, such as temperature sensors, to name one non-limiting example. The sensors and controller for the non-communicating HVAC device may, in some embodiments, be separate components that are retrofit into the HVAC device.

While reference is made herein to HVAC devices, similar systems and methods may be applicable to other types of devices as well, such as water heaters, residential and/or commercial appliances (e.g., refrigerators, dishwashers, etc.), and/or any other type of device. The systems and methods may also be applicable to combinations of these different types of devices as well.

The controller 103 may allow for Bluetooth® connectivity (or other types of short-range connectivity) to the sensors to provide near real-time (or real-time) access to HVAC device data. In addition to this Bluetooth® connectivity, the HVAC device 102 may also be configured to transmit data over a cellular connection to the Internet and to the one or more servers 130. While this may be a reduced set of data when compared to a connected HVAC device as mentioned above, this data may still provide insight to the manufacturer and/or selected third parties.

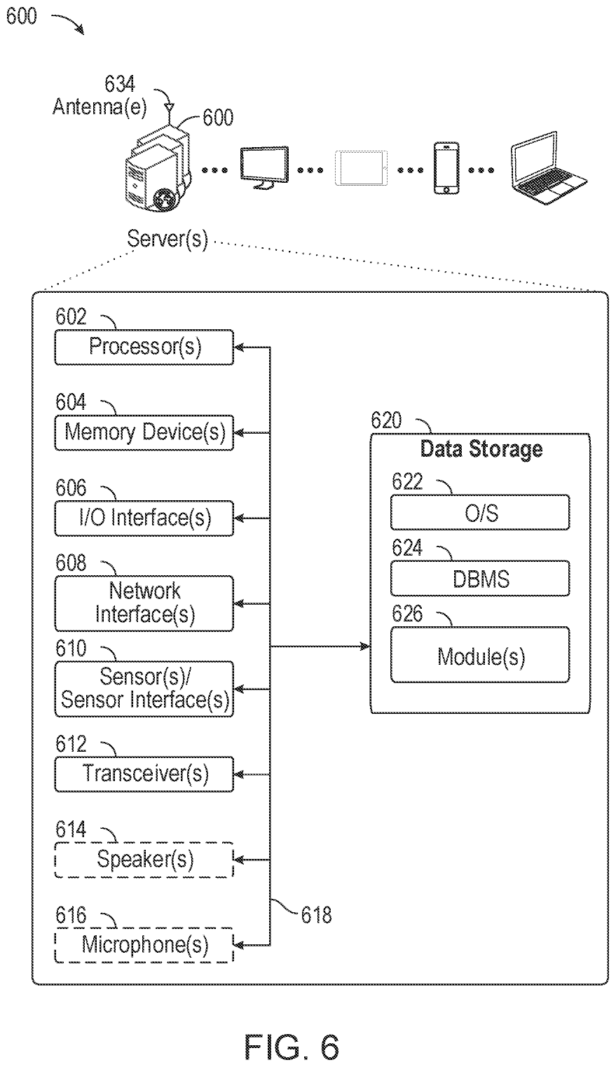

Any of the HVAC devices described herein may also include one or more controller(s). For example, HVAC device 102 is associated with controller 103, HVAC device 108 is associated with controller 109, and HVAC device 114 is associated with controller 115. The controllers may be computing devices (such as computing device 600 described with respect to FIG. 6) that may allow any of the HVAC devices to perform computing functions as described herein (for example, data collection, data transmission, data analysis based on a configuration file, etc.). The controllers may be built-in to the HVAC devices and/or may be standalone devices as well.

Any of the controllers may also store one or more configuration files (for example, configuration file 106 associated with HVAC device 102, configuration file 112 associated with HVAC device 108, configuration file 118 associated with HVAC device 115, configuration file 123 associated with thermostat 123, and/or any other number of configuration files. The figure illustrates one or more configuration files 150 being transmitted from the one or more servers 130 to the HVAC devices through the network 160. For example, a first configuration file 106 is transmitted to the HVAC device 102 and a second configuration file 112 and a third configuration file 118 may be transmitted to the HVAC device 108 and the HVAC device 114.

The individual configuration files may include different data monitoring parameters for the different HVAC devices. For example, the configuration file 112 intended for the HVAC device 108 may indicate that a timed data transmission method should be used and that all data produced by the HVAC device should be transmitted to the one or more servers 130. The configuration file 118 intended for the HVAC device 114 may indicate that a triggered data transmission method should be used and only temperature data should be transmitted to the one or more servers 130.

The data monitoring parameters may also include any other types of information that may be used to dictate how data is captured by an HVAC device and provided to the one or more servers 130. For example, the data monitoring parameters may include different types of data that may be captured by the HVAC device. The data monitoring parameters may also include a format in which the data may be transmitted to the one or more servers 130. The data monitoring parameters may also include calculations or conversions to be performed on the data prior to transmission to one or more servers 130. These are merely a few examples of types of information that may be included in a configuration file and any other information may also be included as well.

Additionally, parameters may be associated with groups of data types and/or may be associated with individual data types. For example, a configuration file may indicate that fan speed data for an air conditioning unit may be transmitted to the one or more servers 130 using a timed data transmission method and temperature data may be transmitted using a triggered data transmission method. As another example, a configuration file may indicate that the fan speed data and the temperature data may both be transmitted using a timed data transmission method, but the time interval for the temperature data may be shorter than the time interval for the fan speed data.

Furthermore, in some instances, a configuration file indicating a triggered data transmission method may also include parameters that trigger actions associated with other types of data as well. For example, the configuration file may indicate that the value of a fan speed of the furnace should be monitored. In addition to this, the configuration file may also include a condition that if the value of the fan speed changes, then not only is the fan speed data provided to the one or more servers 130, but also the temperature data is be obtained and provided to the one or more servers 130 as well. In this manner, the configuration file may also establish conditions that allow for a first type of data (or group of data) to be monitored, but actions to also be taken with respect to a second type of data (or group of data) based on identified changes in value to the first type of data (or group of data).

In embodiments, the data that is collected and transmitted may include any number of different types of data. For example, the data may include sensor data of sensed conditions (e.g., temperature current, voltage, pressure, etc.). The data may also include operating conditions of components (e.g., fan speed, compressor speed, compressor duty cycle, etc.). The data may also include any other types of data as well.

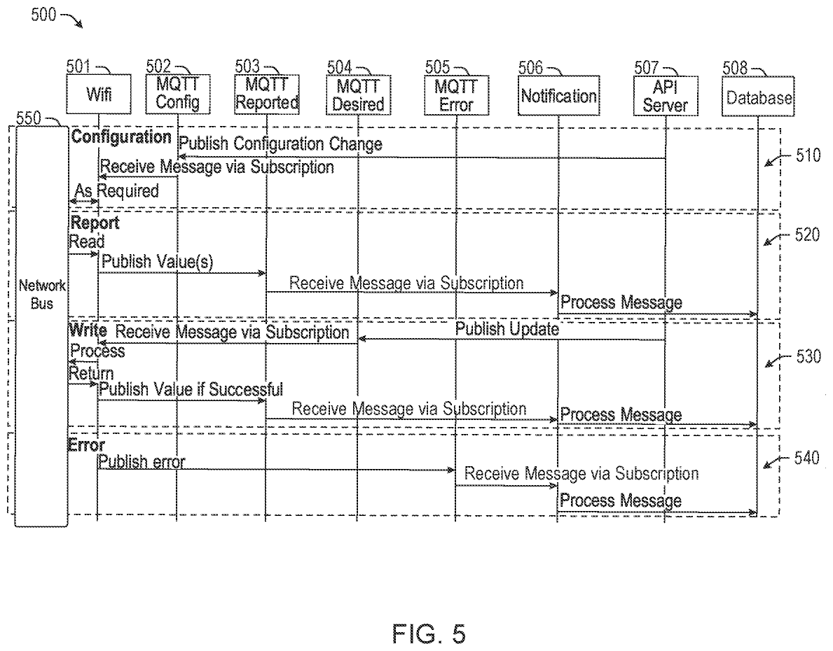

The above description is merely illustrative and not intended to be limiting in any way. For example, any of the configuration files may indicate any of the different types of data transmission triggering methods. Additionally, any of the configuration files may also indicate that any other combinations of different types of data may be monitored. Further, different configuration files may include similar, or the same, data transmission triggering methods and/or types of data that are being monitored. For example, the configuration file 112 and the configuration file 118 may instead both indicate that a timed data transmission method should be used and that the same types of data should be monitored and transmitted back to the one or more servers 130. Additional details about information that may be included in a configuration file is provided with respect to at least FIG. 5.

A configuration file may be transmitted directly from the one or more servers 130 to any of the HVAC devices over the network 160. Particularly, the configuration files may be transmitted to any of the controllers of the HVAC devices. The configuration files may then be stored at the controllers such that a controller may use the configuration file to determine instances in which data associated with the HVAC device should be transmitted back to the one or more servers 130. That is, each controller associated with each HVAC device may manage its own data transmissions through an individual configuration file associated with that HVAC device.

In some instances, however, a configuration file may not necessarily be transmitted directly to an HVAC device, but rather may be transmitted to a second HVAC device that may then transmit the configuration file to a second HVAC device. For example, a configuration file may be transmitted to HVAC device 108, which may then be shared with HVAC device 114. Additionally, in some instances, one device may be configured to manage data transmissions for multiple other devices as well. As one non-limiting example, a configuration file (or multiple configuration files) including data monitoring parameters for the HVAC device 108 and the HVAC device 114 may be transmitted to the thermostat 120. The thermostat may then use the configuration file to manage data transmissions associated with the HVAC device 108 and the HVAC device 114, rather than the controller 109 and the controller 115 managing the data transmissions for the two HVAC devices. The thermostat 120 may store configuration file(s) for multiple HVAC devices and may receive data from the HVAC devices and determine when to report the data to the remote server based on the configuration file(s). Alternatively, the thermostat 120 may query the HVAC devices for data updates.

It should also be noted that while reference is made specifically to a “configuration file” being used to determine the data transmission trigger and/or the types of data that are monitored, these parameters may also be provided to the HVAC device in any other form as well. As one non-limiting example, the one or more servers 130 may simply send instructions to an HVAC device without requiring a file to be stored in memory of a controller of the HVAC device. Further details about how the HVAC devices may be configured to report data are provided with respect to at least FIGS. 2-5.

The one or more servers 130 may include any remote servers that are responsible for monitoring the various HVAC devices (for example, through configuration module 133). The one or more servers 130 may be configured to receive data from any of the various HVAC devices. The one or more servers 130 may also be configured to store the received data. The one or more remote servers 130 may also be configured to perform any other types of functions described herein, such as transmitting configuration files to any of the HVAC devices, as well as any other functions described herein.

The one or more servers 140 may be servers associated with a third party, such as a contractor or other third party partner. The one or more servers 130 may be in communication with the one or more servers 140, such that data obtained from any of the HVAC devices may be shared with the one or more servers 140. This may provide the third parties with information about the HVAC devices that may allow the third parties to more effectively provide service to the customers associated with the HVAC devices. For example, a contractor may view the information provided to the one or more servers 140 to allow for more effective troubleshooting of any of the HVAC devices. In some instances, the server 130 may perform an analysis of the received data and identify particular consumers/particular parts for replacement as opposed to the underlying data collected from the appliance. Alternatively, the server 130 may pass the underlying data collected from the appliance for analysis by the third party.

While data may be shared between the one or more servers 130 and the one or more servers 140, this data sharing may be selective. For example, it may be desirable for a particular third party to only be able to view information about specific HVAC devices rather than all of the HVAC devices that are providing data to the one or more servers 130. Given this, the data that is transmitted to the one or more servers 140 may be limited to only the data that is relevant to the particular third party. Alternatively, the third party may be provided access to the data stored on the one or more servers 130, however, the specific data that the third party is able to access may still be limited to only the data that is relevant to the particular third party.

Any of the components of the system 100 may include at least one or more processors and memory. For example, controller 103 of HVAC device 102 may include processor(s) 104 and memory 105, controller 109 of HVAC device 108 may include processor(s) 110 and memory 111, controller 115 of HVAC device 114 may include processor(s) 116 and memory 117, thermostat 120 may include processors 121 and memory 122, and the one or more server(s) 130 may include processor(s) 131 and memory 132. The processor(s) and memory are described in additional detail with respect to the computing device 600 of FIG. 6. Any of the components of the system 100 may also include any elements described with respect to FIG. 6 as well. The components of the system 100 may also be configured to communicate via a network 160, which may be any type of wired or wireless network. Examples of such networks are also provided with respect to FIG. 6 as well.

Additionally, it should be noted that while reference may be made above to a single element (for example, a configuration file), any such reference may also apply to any other number of such elements as well. For example, the description of a “configuration file 112” may similarly be applicable to multiple of such configuration files and is not necessarily intended to be limiting to only one configuration file.

FIG. 2 is an example flow diagram 200 for a timed data transmission method, in accordance with one or more embodiments of the disclosure. The operations (and conditions) described with respect to the flow diagram 200 of FIG. 2 (and the flow diagram 300 of FIG. 3) may be performed by any of the devices described herein (such as any of the HVAC devices described with respect to FIG. 1). Particularly, the operations (and conditions) may be performed by any of the controllers associated with the HVAC devices. However, the operations (and conditions) may also be performed by any other device as well.

The flow diagram 200 begins with operation 202, which may involve receiving a configuration file. The configuration file may be received by a particular HVAC device that is desired to be monitored by a remote server (such as one or more of the remote servers 130 of FIG. 1). In some instances, the configuration file may be initially provided to the HVAC device at installation. The configuration file for the HVAC device may also be updated at any time, however. For example, the remote server may transmit an updated configuration file to the HVAC device at any time. The updated configuration file may then replace the existing configuration file.

Additionally, as aforementioned, the configuration file may not necessarily be transmitted directly from the remote server to the HVAC device. For example, the configuration file may be transmitted by the remote server to a second device, and then that second device may transmit the configuration file to the HVAC device. The configuration file itself may also not necessarily be provided to the HVAC device, but rather may be stored at another device that may provide control instructions to the HVAC device based on the configuration file (such as thermostat 120 of FIG. 1).

Operation 202 is followed by condition 204. Condition 204 may involve a determination as to whether a time interval has been satisfied. That is, in the timed data transmission method, the configuration file may indicate that the triggering condition for transmitting data from the HVAC device to the remote server (or to other devices) is an amount of time having passed since a prior data transmission was performed. For example, the configuration file may indicate that the HVAC device should provide temperature data in fifteen minute intervals. The configuration file may not necessarily only include one time interval for all types of data, but may also include individual time intervals associated with different types of data and/or groups of data types. If the condition 204 is satisfied, then the flow diagram 200 may proceed to optional condition 206. If the condition 204 is not satisfied, then the condition 204 may be looped until the condition is satisfied.

Optional condition 206 may involve a determination as to whether a change in a value of a given data type has occurred. That is, even if the time interval has been satisfied in condition 204, the HVAC device may still determine not to transmit the data if there has been no change in the value of the data. This may be desirable in some cases to reduce the amount of network bandwidth that is used by such data transmissions. However, in some cases, it may still be desirable to transmit data even if there is no change in the value. For example, to verify that the data is remaining constant (which may be desirable in some cases) and to provide more granular data points for troubleshooting purposes. As with the time intervals, whether condition 206 is used may also vary for individual types of data. That is, the condition may apply to some types of data but not other types of data. These may be defined within the configuration file. If optional condition 206 is satisfied, then the flow diagram 200 may proceed to operation 208. If optional condition 206 is not satisfied, then the flow diagram 200 may return back to condition 204.

Finally, operation 208 may involve transmitting the data to the remote server. That is, the data that is obtained at the time the time interval is satisfied may be transmitted by the HVAC device to the remote server. In some cases, data may be stored within the HVAC device such that the data that is transmitted may include historical data as well, rather than just the data that is captured at the instance in which the time interval is satisfied.

FIG. 3 is an example flow diagram 300 for a triggered data transmission method, in accordance with one or more embodiments of the disclosure. In contrast with the timed data transmission method illustrated in FIG. 2, the triggered data transmission method shown in FIG. 3 may perform data transmissions anytime the data values change, regardless if any time intervals have been satisfied.

Operation 302 may involve receiving a configuration file. The configuration file may be received, for example, in any manner described herein. Operation 302 may be followed by condition 304. Condition 304 may involve a determination as to whether a change in a first data value has occurred. Any number of different types of data may be defined in the configuration file as the trigger data. As an example, the first data value may be associated with a fan speed of a fan included within an air conditioning unit. If the rotations per minute (RPM) of the fan changes from 0 to 1,000, then the condition 304 may be satisfied because the value of the fan speed changed. A change of this magnitude is not necessarily required for condition 304 to be satisfied. For example, a change from 3,000 to 3,005 RPM (or any other change) may also be sufficient for condition 304 to be satisfied.

Condition 304 may be followed by optional condition 306. Optional condition 306 may involve a determination as to whether the change identified in condition 304 satisfied a threshold amount of change. That is, the configuration file may also include threshold values that must be met before the triggering conditions associated with any of the data types are satisfied. Such thresholds may be used to ensure that only changes of a non-negligible degree are transmitted to the remote server to limit the amount of bandwidth that is used for such transmissions. The threshold amount may be a predetermined magnitude of change, a rate of change, a frequency of change, or any other amount. Continuing the above example, a threshold of 100 RPM may be established for the fan speed data. If the fan speed changes by less than 100 RPM, then condition 306 may not be satisfied and the fan speed data may not be transmitted to the remote server. However, these threshold values may not necessarily be used with respect to some HVAC devices and/or some of the data types, and instead, data may be transmitted anytime the data values change, regardless of the degree of the change. Additionally, the example provided above is not intended to be limiting. The threshold may similarly apply to any other types of data and may be any other value. Further, “satisfying” a threshold may refer to any of: greater than, greater than or equal to, equal to, less than, or less than or equal to the threshold value.

If condition 304 and optional condition 306 (if applicable) are satisfied, then the flow diagram 300 may proceed to operation 308. Operation 308 may involve transmitting the first data to the remote server. That is, the data that is obtained at the time the condition(s) is/are satisfied may be transmitted by the HVAC device to the remote server. In some cases, data may be stored within the HVAC device such that the data that is transmitted may include historical data as well, rather than just the data that is captured at the instance in which the condition(s) is/are satisfied.

The flow diagram also illustrates a second set of conditions (conditions 310 and 312) for a second type of data. In this manner, the figure illustrates that the configuration file may include monitoring parameters for more than one type of data that can potentially be monitored in an HVAC device.

Optional condition 310 may involve a determination as to whether a change in a second data value has occurred. Optional condition 312 may involve a determination as to whether the change identified in condition 310 satisfied a threshold amount of change. Finally, operation 314 may involve transmitting the second data to the remote server.

The illustration in FIG. 3 of only two different types of data being monitored is only exemplary and is not intended to be limiting. Any other number of types of data may also be monitored with respect to a given HVAC device as well (including only one type of data).

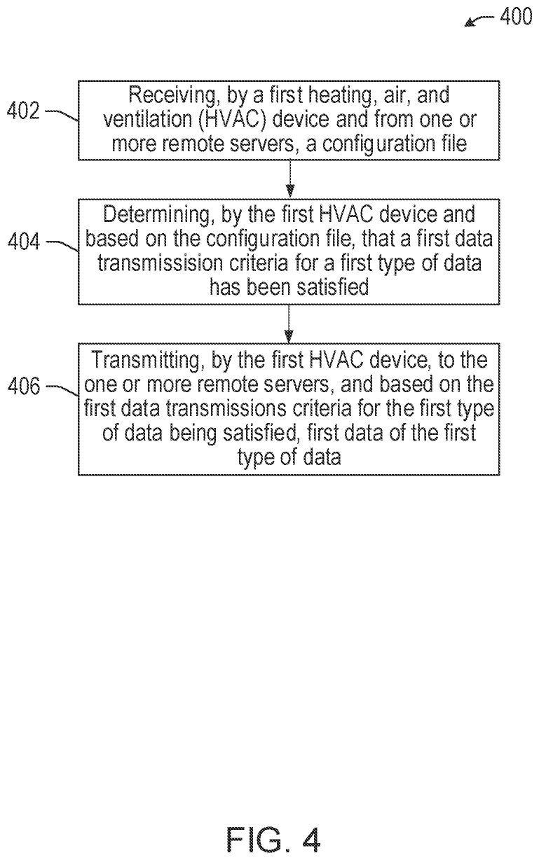

FIG. 4 is an example method 400 for remote device monitoring, in accordance with one or more embodiments of the disclosure. In one or more embodiments, the method may be implemented by any device or system described herein (for example, HVC device 102, HVAC device 108, HVAC device 114, thermostat 120, one or more servers 130, and/or any other device or system).

Block 402 of the method 400 may include receiving, by a first heating, ventilation, and air conditioning (HVAC) device and from one or more remote servers, a configuration file. Block 404 of the method 400 may include determining, by the first HVAC device and based on the configuration file, that a first data transmission criteria for a first type of data has been satisfied. Block 406 of the method 400 may include transmitting, by the first HVAC device, to the one or more remote servers, and based on the first data transmission criteria for the first type of data being satisfied, first data of the first type of data.

One or more operations of the methods, process flows, or use cases of FIGS. 1-4 may have been described above as being performed by a user device, or more specifically, by one or more program module(s), applications, or the like executing on a device. It should be appreciated, however, that any of the operations of the methods, process flows, or use cases of FIGS. 1-4 may be performed, at least in part, in a distributed manner by one or more other devices, or more specifically, by one or more program module(s), applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-4 may be described in the context of the illustrative devices, it should be appreciated that such operations may be implemented in connection with numerous other device configurations.

The operations described and depicted in the illustrative methods, process flows, and use cases of FIGS. 1-4 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

FIG. 5 is an example flow diagram 500 illustrating network communications, in accordance with one or more embodiments of the disclosure. Particularly, the figure may provide a more specific example of how communications between the one or more remote servers 130 and the HVAC devices in FIG. 1 (as well as any other elements of the system 100) may be performed.

In one or more embodiments, communications to and from any remote servers (for example, between the HVAC devices and any remote servers) may be performed via message queuing telemetry transport (MQTT) using JavaScript Object Notion (JSON)-based commands (or any other type of format). MQTT is a client/server publish and subscribe messaging transport protocol. MQTT is a simple messaging protocol that is designed for communications between constrained devices with low bandwidth. For example, MQTT may often be used to exchange data between multiple Internet-of-Things (IoT) devices. Data may be subscribed to by a “Wi-Fi translator” 501, such that actions at any remote servers may be automatically relayed to the Wi-Fi translator 501. This example provided in FIG. 5 is not intended to be limiting and communications may be performed in any other suitable manner. For example, any of the HVAC devices may similarly include transceivers configured for other types of communications, such as Wi-Fi or cellular in addition to (or alternatively to) the MQTT communications methods described herein.

The Wi-Fi translator 501 my interface the remote server(s) with any devices (for example, HVAC devices) that may be connected to the network bus 550. The Wi-Fi translator 501 may perform any conversions between a format associated with the network bus 550 and JSON, and may then perform the communications over MQTT topics. The Wi-Fi translator 501 may allow for monitoring and control of a selected HVAC device on the network bus 550 to be performed through access to the underlying network objects on the HVAC devices. The Wi-Fi translator may allow updating of the HVAC device firmware and the Wi-Fi translator firmware as well.

With MQTT, devices may publish messages regarding specific “topics.” All devices that are subscribed to that topic may then receive any message identified as relating to the topic. For example, a first device publishes on a topic. A second device is subscribed to the same topic on which the first device is publishing. Given this, the second device may receive any messages published to the topic by the first device. A specified set of MQTT topics may be used for communications between the remote server(s) and n HVAC device through the Wi-Fi translator 501. The topics may specify the identification of the Wi-Fi translator 501 and both the type and identification of the HVAC device.

Examples of MQTT topics used with respect to the systems and method described herein may include at least a “config” topic 502, a “reported” topic 503, a “desired” topic 504, and/or an “error” topic 505. Any other types of topics may also be used, such as “time,” “format,” “trigger,” etc. In one or more embodiments, the config topic 502 may relate to any operations associated with configuration files as described herein and is described in additional detail below. The reported topic 503 may include at least any messages sent to and/or from the Wi-Fi translator 501. The desired topic 504 may be involved in at least write operations as described below. The error topic 505 may include any transmitted error messages. The above descriptions of these various topics are not intended to be limiting, but merely provide a high-level description of each topic.

The communications may be performed in the following format, for example: device/MAC_ADDRESS_SERIAL_N_INSTANCE/DEVICE_BASE_ADDRESS/TOPIC_IDENTIFIER. MAC_ADDRESS may indicate the MAC address of the Wi-Fi translator 501 through which communications may occur. SERIAL_N_INSTANCE may indicate The serial number of the HVAC device (and/or any other type of identifier). DEVICE_BASE_ADDRESS may indicate a cloud system identification of an HVCA device on the network bus 550. SOFTWARE_VERSION may indicate the HVACA device control software version identifier. TOPIC_IDENTIFIER may refer to the topic type to identify content and usage of the messages.

The config topic 502 may include several sub-commands. Examples of such sub-commands may include at least “auto-poll,” “preserve,” “format,” “trigger,” “alias,” and “schedule.” The auto-poll command may include a list of object (for example, device) names and a desired polling frequency at which data produced by the object should be reported to the remote server. Auto-Polling may allow a remote server to request automatic periodic updates of specified objects from the translator module. These automatic updates may occur without re-transmission of the request. This operation is initiated by publication of an auto-poll “config” message. The auto-poll configuration may persist even with a loss of connection to the MQTT server to support the “preserve” command. Publication of one auto-poll setup message for a product may be triggered by subscription of the translator module to the “config” topic for that product at connection startup. This message may include one or more lists. Subsequently, the cloud server may publish a new auto-poll setup message for a product to the “config” topic. Upon such publication, the Wi-Fi translator 501 may delete any previous auto poll setup and replace it with the setup specified by the new message. There may be two supported auto-poll request types: on-demand and repeating requests.

On-Demand auto-poll requests may be designated by setting the requested frequency to 0. The objects in these requests may be reported only once when the auto-poll configuration is received. These objects may not be stored and may not be used as the “monitor” object in a trigger request.

Repeating auto-poll requests may include any request block that has a frequency value greater than 0. Objects in these requests may be reported once when the auto-poll configuration is received and then, if they have changed, periodically at the rate specified by the “frequency” parameter. The frequency, for example, may be specified in whole, integer, seconds. This value may represent the maximum rate the translator may report the values of the objects specified in the request. The object's value may be checked at the specified frequency; if the value has changed since it was last reported, the new value may be reported. If the value has not changed, it may not be not reported. Each request may include one key-value pair that specifies a polling frequency and one key-value pair in which the value is an array of objects on the product to be polled at the specified frequency.

The preserve command may define objects that my be data logged in the event of a loss of a network connection. For example, when a network connection loss occurs, the device may begin or continue to store data at a given frequency. When the connection is re-established, this data may then be forwarded to the remote server. The purpose of triggering is to ensure that whenever the value of a “triggering” object is published due to a change in that value, the current values/formatting of one or more additional associated objects are also available and may be published if updated. In some cases, that only objects that exist in the “auto-poll” list may be utilized in the “trigger” command.

The format command may provide an indication of data formatting to be used by the object. The format command may be published by the cloud on the “config” topic to a device. This allows the cloud to request format information about specific objects in a device. Typically, such a request may occur if the remote server identifies a “software version” that does not contain format information. If the name of an object in the format message is incorrect such that the object is not present on the device, its value may be published as an error message on the “format” topic.

The trigger command may provide an indication of the objects to be monitored and the triggers that result in data transmission. The purpose of triggering is to ensure that whenever the value of a “triggering” object is published due to a change in that value, the current values/formatting of one or more additional associated objects are also available and may be published if updated. In some cases, only objects that exist in the “auto-poll” list may be utilized in the “trigger” command. A non-limiting example format of a trigger command message is shown below.

{
“config” : “trigger”,
“triggers” : [
{ “monitor” : “ObjectT1”,
“value” : [“Object1”, “Object2”,..., “Objectx”],
“format” : [“Object1”, “Object2”,..., “Objectx”]
},
{ “monitor” : “ObjectT2”,
“value” : [“Object1”, “Object2”,..., “Objectx”],
“format” : [“Object1”, “Object2”,..., “Objectx”]
},
... ,
{ “monitor” : “ObjectTn”,
“value” : [“Object1”, “Object2”,..., “Objectx”],
“format” : [“Object1”, “Object2”,..., “Objectx”]
}
],
“transactionId” : “string”
}

With respect to this example command, if a change is detected in the value of the “monitor” object, then the values of each object in the “value” list may be read from the network bus 550. If the value of a given object in the “value” list has changed since it was last published, then the updated value may be published. All objects in the “value” list whose values have changed may be published as one message (or separate messages). If no change in value is detected for any of the objects in the “value” list, then no message may be published.

All messages originating from the remote server may include a transaction identifier that may uniquely identify the message. For the “auto-poll” command over the “config” topic, an indexing method may be used to append to the transaction identifier in order to specifically identify the particular “list”/request within the “auto-poll” command when responding to the “reported” and “error” topics. For the “format” command over the “config” topic, an indexing method may be used to append to the transaction identifier in order to specifically identify the particular “object name” within the “format” command when responding to the “format” and “error” topics. For example, ‘transactionID’+‘_’+‘01’ or all together: ‘transactionID_01’ The number appended to the transactionID string may be in hexadecimal format for the “format” command.

Maintaining an accurate local time may be important for several operations of the Wi-Fi translator 501, including establishing a secure cloud connection. Because this module may be unable to preserve the current time across a power cycle, the current time may be retrieved from a remote time server after every power cycle. The drift of this module's real-time clock provides the device with the ability to maintain the time within a tolerable accuracy for at least one day. To support connections lasting longer than this period, the Wi-Fi translator 501 may support a mechanism to have the current time refreshed by the cloud. Providing the desired user experience across the connected devices requires that the cloud also provide the Wi-Fi module with the current time zone offset. The offset may be based on the device's location which the user provides during provisioning.

Turning to the flow diagram 500, several sub-flows are illustrated. A first sub-flow 510 may include a configuration sub-flow. The first sub-flow may begin with publishing a configuration change by an API server 507 to an MQTT config topic 502. The Wi-Fi translator 501 may receive the configuration change via a subscription to the MQTT config topic. The configuration change may also be provided to the network bus 550.

A second sub-flow 520 may include a reporting sub-flow. The sub-flow 520 may begin with the bus performing a read operation with respect to the Wi-Fi translator 501. The Wi-Fi translator 501 may then publish any values to the MQTT reported topic 503. A notification server 506 may then receive the published values based on a subscription to the MQTT reported topic. The notification server 506 may process the message and provide the message to a database 508.

A third sub-flow 530 may include a write sub-flow. The sub-flow 530 may begin with the API server 507 publishing an update to the MQTT desired topic 504. The Wi-Fi translator 501 may receive the published update via a subscription to the MQTT desired topic 504. The message may be provided to the network bus 550 for processing. The network bus 550 may return the processed message to the Wi-Fi translator 501. The Wi-Fi translator 501 may then publish the value to the MQTT reported topic 503 if successful. The notification server 506 may receive the indication that the values were published based on the subscription to the MQTT reported topic 503. The notification server 506 may then provide the message to the database 508 for processing.

A fourth sub-flow 540 may include an error sub-flow. The sub-flow 540 may begin with the network bus 550 publishing an indication of an error to the MQTT error topic 505. The notification server 506 may receive an indication of the published error from the MQTT error topic 505. The indication of the error may be provided to the database 508 for processing.

FIG. 6 is a schematic block diagram of one or more illustrative computing device(s) 600 in accordance with one or more example embodiments of the disclosure. The computing device(s) 600 may include any suitable computing device including, but not limited to, a server system, a mobile device such as a smartphone, a tablet, an e-reader, a wearable device, or the like; a desktop computer; a laptop computer; a content streaming device; a set-top box; or the like. The computing device(s) 600 may correspond to an illustrative device configuration for any of the computing systems described herein and/or any other system and/or device.

The computing device(s) 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device(s) 600 may include one or more processor(s) 602, one or more memory devices 604 (generically referred to herein as memory 604), one or more input/output (I/O) interfaces 606, one or more network interfaces 608, one or more sensors or sensor interfaces 610, one or more transceivers 612, one or more optional speakers 614, one or more optional microphones 616, and data storage 620. The computing device(s) 600 may further include one or more buses 618 that functionally couple various components of the computing device(s) 600. The computing device(s) 600 may further include one or more antenna(e) 634 that may include, without limitation, a cellular antenna for transmitting or receiving signals to/from a cellular network infrastructure, an antenna for transmitting or receiving WiFi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit the exchange of information (e.g., data (including computer-executable code), signaling, etc.) between various components of the computing device(s) 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 604 of the computing device(s) 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage, including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. Moreover, output data generated as a result of execution of the computer-executable instructions by the processor(s) 602 may be stored initially in the memory 604, and may ultimately be copied to the data storage 620 for non-volatile storage.

More specifically, the data storage 620 may store one or more operating systems (O/S) 622; one or more database management systems (DBMS s) 624; and one or more program module(s), applications, engines, computer-executable code, scripts, or the like such as, for example, one or more data management module(s) 626, one or more data analysis module(s) 628, and/or one or more OBD module(s) 630. Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The data storage 620 may further store various types of data utilized by the components of the computing device(s) 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 602 may be configured to access the memory 604 and execute the computer-executable instructions loaded therein. For example, the processor(s) 602 may be configured to execute the computer-executable instructions of the various program module(s), applications, engines, or the like of the computing device(s) 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a reduced instruction set computer (RISC) microprocessor, a complex instruction set computer (CISC) microprocessor, a microcontroller, an application-specific integrated circuit (ASIC), a field-programmable gate array (FPGA), a system-on-a-chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to functionality supported by the various program module(s) depicted in FIG. 6, the module(s) 626 may include computer-executable instructions, code, or the like that responsive to execution by one or more of the processor(s) 602 may perform functions including, but not limited to, performing verification of any data produced by a sensor in accordance with the algorithm described herein, sending signals to various components of the furnace to perform functions in association with the verification of the data (for example, a signal to adjust a motor speed of the inducer blower), and/or any other functions described herein.

Referring now to other illustrative components depicted as being stored in the data storage 620, the O/S 622 may be loaded from the data storage 620 into the memory 604 and may provide an interface between other application software executing on the computing device(s) 600 and the hardware resources of the computing device(s) 600. More specifically, the O/S 622 may include a set of computer-executable instructions for managing hardware resources of the computing device(s) 600 and for providing common services to other application programs (e.g., managing memory allocation among various application programs). The O/S 622 may include any operating system now known or which may be developed in the future, including, but not limited to, any server operating system, any mainframe operating system, or any other proprietary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device(s) 600 is a mobile device, the DBMS 624 may be any suitable lightweight DBMS optimized for performance on a mobile device.

Referring now to other illustrative components of the computing device(s) 600, the input/output (I/O) interface(s) 606 may facilitate the receipt of input information by the computing device(s) 600 from one or more I/O devices as well as the output of information from the computing device(s) 600 to one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device(s) 600 or may be separate. The I/O devices may further include, for example, any number of peripheral devices such as data storage devices, printing devices, and so forth.

The I/O interface(s) 606 may also include an interface for an external peripheral device connection such as a universal serial bus (USB), FireWire, Thunderbolt, Ethernet port or other connection protocol that may connect to one or more networks. The I/O interface(s) 606 may also include a connection to one or more of the antenna(e) 634 to connect to one or more networks via a wireless local area network (WLAN) (such as WiFi) radio, Bluetooth, ZigBee, and/or a wireless network radio, such as a radio capable of communication with a wireless communication network such as a Long Term Evolution (LTE) network, WiMAX network, 3G network, etc.

The computing device(s) 600 may further include one or more network interface(s) 608 via which the computing device(s) 600 may communicate with any of a variety of other systems, platforms, networks, devices, and so forth. The network interface(s) 608 may enable communication, for example, with one or more wireless routers, one or more host servers, one or more web servers, and the like via one or more networks.

The antenna(e) 634 may include any suitable type of antenna depending, for example, on the communications protocols used to transmit or receive signals via the antenna(e) 634. Non-limiting examples of suitable antennae may include directional antennae, non-directional antennae, dipole antennae, folded dipole antennae, patch antennae, multiple-input multiple-output (MIMO) antennae, or the like. The antenna(e) 634 may be communicatively coupled to one or more transceivers 612 or radio components to which or from which signals may be transmitted or received.

As previously described, the antenna(e) 634 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 634 may additionally, or alternatively, include a WiFi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 634 may be configured to transmit or receive radio frequency signals within any suitable frequency range forming part of the unlicensed portion of the radio spectrum.

The antenna(e) 634 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(e) 634—transmitting or receiving radio frequency (RF) signals in the bandwidth and/or channels corresponding to the communications protocols utilized by the computing device(s) 600 to communicate with other devices. The transceiver(s) 612 may include hardware, software, and/or firmware for modulating, transmitting, or receiving—potentially in cooperation with any of antenna(e) 634—communications signals according to any of the communications protocols discussed above including, but not limited to, one or more WiFi and/or WiFi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the computing device(s) 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The speaker(s) 614 may be any device configured to generate audible sound. The microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), application programming interface(s) (API(s)), or any other suitable computer-executable code hosted locally on the computing device(s) 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the computing device(s) 600 may include alternate and/or additional hardware, software, or firmware components beyond those described or depicted without departing from the scope of the disclosure. More particularly, it should be appreciated that software, firmware, or hardware components depicted as forming part of the computing device(s) 600 are merely illustrative and that some components may not be present or additional components may be provided in various embodiments. While various illustrative program module(s) have been depicted and described as software module(s) stored in the data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-3 may be performed by a device having the illustrative configuration depicted in FIG. 6, or more specifically, by one or more engines, program module(s), applications, or the like executable on such a device. It should be appreciated, however, that such operations may be implemented in connection with numerous other device configurations.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component including assembly language instructions may require conversion into executable machine code by an assembler prior to execution by the hardware architecture and/or platform.

Another example programming language may be a higher-level programming language that may be portable across multiple architectures. A software component including higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component including instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may include other custom-developed application software, operating system functionality (e.g., device drivers, data storage (e.g., file management) routines, other common routines, and services, etc.), or third party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A system comprising:
one or more processors; and
memory storing computer-executable instructions that, when executed by the one or more processors, cause the one or more processors to:
receive, by a first heating, ventilation, and air conditioning (HVAC) device and from one or more remote servers, a configuration file;
determine, based on the configuration file, that a first data transmission criteria for a first type of data is satisfied; and
transmit, to the one or more remote servers, and based on the first data transmission criteria for the first type of data being satisfied, first data of the first type of data.

2. The system of claim 1, wherein the first data transmission criteria comprises a first time interval.

3. The system of claim 2, wherein the computer-executable instructions further cause the one or more processors to:
determine, by the first HVAC device, that a second data transmission criteria for the first type of data has been satisfied,
wherein transmitting the first data to the one or more remote servers is further based on the second data transmission criteria being satisfied, and
wherein the second data transmission criteria comprises a change in a value of the first type of data.

4. The system of claim 1, wherein the first data transmission criteria comprises a change in a value of the first type of data.

5. The system of claim 1, wherein the computer-executable instructions further cause the one or more processors to:
determine, by the first HVAC device and based on the configuration file, that a second data transmission criteria for a second type of data has been satisfied, wherein the second type of data is different than the first type of data; and
transmit, by the first HVAC device, to the one or more remote servers, and based on the second data transmission criteria for the second type of data being satisfied, second data of the second type of data.

6. The system of claim 1, wherein the computer-executable instructions further cause the one or more processors to:
receive, by a second HVAC device and from the one or more remote servers, a second configuration file; and
transmit, by the second HVAC device and to a third HVAC device, the second configuration file.

7. The system of claim 1, wherein the computer-executable instructions further cause the one or more processors to:
receive, by a second HVAC device and from the one or more remote servers, a second configuration file;
receive, by the second HVAC device and from a third HVAC device, second data;
determine, by the second HVAC device and based on the second configuration file, that a second data transmission criteria for a second type of data has been satisfied; and
transmit, by the second HVAC device, to the one or more remote servers, and based on the second data transmission criteria for the second type of data being satisfied, the second data.

8. The system of claim 1, wherein the one or more remote servers are configured to store the first data.

9. The system of claim 1, wherein the one or more remote servers are configured to provide access to the first data by one or more third party servers based on one or more access rules.

10. A method comprising:
receiving, by a first heating, ventilation, and air conditioning (HVAC) device and from one or more remote servers, a configuration file;
determining, by the first HVAC device and based on the configuration file, that a first data transmission criteria for a first type of data has been satisfied; and
transmitting, by the first HVAC device, to the one or more remote servers, and based on the first data transmission criteria for the first type of data being satisfied, first data of the first type of data.

11. The method of claim 10, wherein the first data transmission criteria comprises a first time interval.

12. The method of claim 11, further comprising:
determining, by the first HVAC device, that a second data transmission criteria for the first type of data has been satisfied,
wherein transmitting the first data to the one or more remote servers is further based on the second data transmission criteria being satisfied, and
wherein the second data transmission criteria comprises a change in a value of the first type of data.

13. The method of claim 10, wherein the first data transmission criteria comprises a change in a value of the first type of data.

14. The method of claim 10, further comprising:
determining, by the first HVAC device and based on the configuration file, that a second data transmission criteria for a second type of data has been satisfied, wherein the second type of data is different than the first type of data; and
transmitting, by the first HVAC device, to the one or more remote servers, and based on the second data transmission criteria for the second type of data being satisfied, second data of the second type of data.

15. The method of claim 10, wherein the one or more remote servers are configured to provide access to the first data by one or more third party servers based on one or more access rules.

16. A heating, ventilation, and air conditioning (HVAC) device comprising:
one or more processors; and
memory storing computer-executable instructions that, when executed by the one or more processors, cause the one or more processors to:
receive, by the HVAC device and from one or more remote servers, a configuration file;
determine, by the HVAC device and based on the configuration file, that a first data transmission criteria for a first type of data has been satisfied; and
transmit, by the HVAC device, to the one or more remote servers, and based on the first data transmission criteria for the first type of data being satisfied, first data of the first type of data.

17. The HVAC device of claim 16, wherein the first data transmission criteria comprises a first time interval.

18. The HVAC device of claim 17, wherein the computer-executable instructions further cause the one or more processors to:
determine that a second data transmission criteria for the first type of data has been satisfied,
wherein transmitting the first data to the one or more remote servers is further based on the second data transmission criteria being satisfied, and
wherein the second data transmission criteria comprises a change in a value of the first type of data.

19. The HVAC device of claim 16, wherein the first data transmission criteria comprises a change in a value of the first type of data.

20. The HVAC device of claim 16, wherein the computer-executable instructions further cause the one or more processors to:
determine, based on the configuration file, that a second data transmission criteria for a second type of data has been satisfied, wherein the second type of data is different than the first type of data; and
transmit to the one or more remote servers, and based on the second data transmission criteria for the second type of data being satisfied, second data of the second type of data.
